(19) United States
(12) Patent Application Publication
(10) Pub. No.: US 2009/0117468 A1
(43) Pub. Date: May 7, 2009

(54) ANODE ACTIVE MATERIAL AND METHOD OF MANUFACTURING THE SAME AND LITHIUM SECONDARY BATTERY USING THE SAME

(75) Inventor: Jiyong EOM, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd, Suwon-si (KR)

(21) Appl. No.: 12/181,586

(22) Filed: Jul. 29, 2008

(30) Foreign Application Priority Data
Nov. 2, 2007 (KR) 2007-111582

(51) Int. Cl. H01M 4/58; H01M 4/04

(52) U.S. Cl. 429/231.8; 423/324; 423/447.1; 977/846; 977/948

(57) ABSTRACT

An anode active material that can prominently improve lifetime characteristics of a lithium secondary battery includes carbon nanotubes and silicon particles located in an internal space of the carbon nanotubes. The anode active material is manufactured by removing end caps of the carbon nanotubes to provide carbon nanotubes having lengths in the range of 0.1 to 10 μm, and filling an interior space of the carbon nanotubes with silicon particles. In addition, a lithium secondary battery comprises an anode including an anode collector and the anode active material, a cathode including a cathode collector and cathode active material, and a separator interposed between the anode and the cathode. The anode active material includes carbon nanotubes and silicon particles located in internal spaces of the carbon nanotube.

### CROSS-REFERENCE TO RELATED APPLICATION

This application claims the benefit of Korean Application No. 2007-111582 filed Nov. 2, 2007, in the Korean Intellectual Property Office, the disclosure of which is incorporated herein by reference.

### BACKGROUND OF THE INVENTION

1. Field of the Invention

Aspects of the present invention relate to an anode active material, a method of manufacturing the same and a lithium secondary battery using the same that can prominently improve lifetime characteristics.

2. Description of the Related Art

The lithium secondary battery, widely used as a power source in portable small electronic devices, has a discharge voltage that is more than two times higher than that of a conventional alkaline battery and has a high energy density.

Oxides made up of lithium and transition metals having intercalation structure, such as LiCoO₂, LiMn₂O₄, LiNi₁₋ₓCoₓO₂(0≦X≦1) and the like, are typically used as a cathode active material of the lithium secondary battery.

A lithium metal having a very high energy density has been conventionally proposed as the anode active material of the lithium secondary battery. However, with lithium metal, dendrites are formed in the anode at charging, and internal shorts may occur if the dendrites penetrate into the separator and reach the cathode during continuous charging/discharging. The deposited dendrites rapidly increase reactivity according to an increase of the specific surface area of the lithium electrode, react with electrolyte in a surface of the electrode and lead to the formation of a polymer film that lacks electrical conductivity. Accordingly, electric resistance rapidly increases, and particles isolated from a network of electric conduction are formed, thereby inhibiting discharge of the battery.

Accordingly, a method using a carbon material capable of absorbing and emitting lithium ions as the anode active material instead of lithium metal has been proposed. Generally, a graphite anode active material does not form lithium metal deposits so that dendrites and internal shorts are not generated. However, graphite has a theoretical lithium absorbing capacity of 372 mAh/g, which is very small capacity corresponding to 10% of the ion capacity of lithium metal. Accordingly, a method additionally including silicon particles in an anode active material has been proposed. The capacity of the lithium secondary battery is increased by using silicon particles, the lifetime of the battery according to an increase of the number of charging/discharging is degraded.

### SUMMARY OF THE INVENTION

Aspects of the present invention provide an anode active material, a method for manufacturing the same and a lithium secondary battery using the same that can prominently improve lifetime characteristics.

According to one embodiment of the present invention, there is provided an anode active material, which includes carbon nanotubes (CNTs) and silicon particles located an internal space of the carbon nanotubes. The anode active material may be formed by filling carbon nanotubes with silicon particles. The length of the carbon nanotubes may be in the range of 0.1 to 10 μm, or as a non-limiting example, 0.1 to 5 μm. The carbon nanotubes may be multi-wall nanotubes or single wall nanotubes. The silicon particles may comprise less than 50 wt % of the total anode active material. The anode active material may be formed by removing end caps of carbon nanotubes and filling the interior of the carbon nanotubes with the silicon particles.

According to another embodiment of the present invention, there is provided a lithium secondary battery, which includes: an anode having an anode collector and an anode active material; a cathode having a cathode collector and cathode active material; and a separator interposed between the cathode and the anode, wherein the anode active material includes silicon particles and carbon nanotubes, and the silicon particles are located in an inner space of the carbon nanotubes.

According to a still another embodiment of the present invention, there is provided a manufacturing method of an anode active material, which includes: preparing carbon nanotubes; removing end caps of the carbon nanotubes and to provide carbon nanotubes having lengths in the range of 0.1 to 10 μm and filling the carbon nanotubes with silicon particles.

The carbon nanotubes may be filled with the silicon particles by a capillary action.

The anode active material according to aspects of the present invention may be manufactured by the manufacturing method of the anode active material.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view illustrating an anode for a lithium secondary battery according to an embodiment of the present invention;

FIG. 2 is a photograph illustrating carbon nanotubes;

FIG. 3 is a photograph illustrating carbon nanotubes that have been subjected to chemical etching method;

FIG. 4 is a photograph illustrating carbon nanotubes filled with silicon particles;

FIG. 5 is an exploded perspective view illustrating an electrode assembly of the lithium secondary battery according to an embodiment of the present invention;

FIG. 6 is a perspective view of the electrode assembly shown in FIG. 5 in assembled form; and

FIG. 7 is a graph illustrating life characteristics of the lithium secondary battery using an anode active material according to examples of the present invention and according to comparative examples.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinafter, an anode active material for a lithium secondary battery and a method for manufacturing the same according to an embodiment of the present invention will be explained in detail.

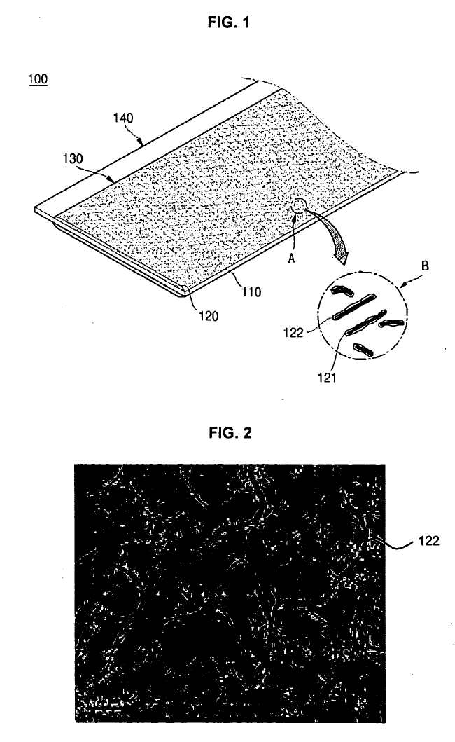

FIG. 1 is a perspective view illustrating an anode for the lithium secondary battery according to an embodiment of the present invention. Referring to FIG. 1, the anode 100 for the lithium secondary battery includes an anode collector 110 and an anode active material 120 formed on the anode collector 110. The anode active material 120 includes silicon particles 121 and carbon nanotubes 122.

The anode active material 120 is not formed on the entire anode collector 110. Thus, the anode 100 includes an anode coated part 130, where the anode collector 110 is coated with the anode active material 120 and an anode uncoated part 140 disposed near the anode coated part 130, where the anode collector 110 is exposed.

The anode collector 110 collects electrons generated by the electrochemical reaction of the anode active material 120 and/or supplies the electrons necessary for the electrochemical reaction. A material that forms an alloy with lithium in a deposition potential of the lithium metal in an organic electrolytic solution may used as the anode collector 100. For example, the anode collector 110 may be made of thin copper foil, having, for example, a thickness of 10 to 30 μm. The anode collector 110 may be formed in a band shape, that is, extended in one direction. The anode uncoated part 140 may be connectedly situated along one side of the anode coated part 130 in a length direction of the anode collector 110. It is to be understood that other structures may be used for the anode 100.

The anode active material 120 is a compound layer including the anode electrode active material, a binder and the like. The anode active material 120 generates and/or consumes electrons by the electrochemical reaction, and provides the electrons to an external circuit through the anode collector 110.

The anode active material 120 is formed by coating a slurry of the anode active material 120, obtained after mixing and dispersing the anode active material 120 and the binder in solvent, onto the anode collector 110, and drying and rolling the anode active material 120. A non-aqueous solvent or an aqueous solvent may be used as the solvent when mixing and dispersing the anode active material 120, the binder and the like.

N-methyl-2-pyrrolidone (NMP), dimethyl formamide (DMF), tetrahydrofuran (THF) and the like may be used as the non-aqueous solvent. As the binder, a fluorine containing binder such as polyvinylidene fluoride (PVDF), a copolymer of vinylidene chloride and the like or a styrene-butadiene rubber (SBR) binder may be used. A viscosity increasing agent may be additionally included when using the SBR binder. The viscosity increasing agent may be at least one selected from the group consisting of carboxy methyl cellulose, hydroxyl methyl cellulose, hydroxyl ethyl cellulose and hydroxyl propyl cellulose. The content of the binder should be in a proper range so as provide a satisfactory adhering force between the anode active material 120 and the anode collector 110, and to provide a high capacity for the lithium secondary battery.

As the anode active material 120, lithium metal, a metal material capable of alloying with lithium, transition metal oxides, material capable of being doped or undoped with lithium, material capable of forming a compound by reversibly reacting with lithium or material capable of reversibly intercalating/deintercalating lithium ions and the like may be used.

In particular, the anode active material 120 according to aspects of the present invention includes carbon as the material capable of reversibly intercalating/deintercalating the lithium ions, more particularly, carbon nanotubes 122 filled with silicon particles 121, as shown FIG. 1 in the region “B,” which is an enlargement of the region “A” of the anode 100. Referring to region “B” of FIG. 1, the anode active material 120 has a structure in which silicon particles 121 are arranged in an internal space of the carbon nanotubes 122. Carbon material is not coated onto the silicon particles 121, but rather, the silicon particles 121 fill the inside of the carbon nanotubes 122.

Since the anode active material 120 includes the carbon nanotubes 122 as the carbon material, lithium metal is not deposited even when there is repeating charging/discharging of the lithium secondary battery. Thus, a danger of an internal short or fire is prevented. In addition, since the anode active material 120 includes the silicon particles 121, the capacity of the lithium secondary battery is greatly increased.

The carbon nanotubes 122 have a strength of about 1,000 times of steel strength. Thus, the shrinkage and expansion of a silicon material during a repetition of a charging cycle is prevented by the carbon nanotubes 122 because the silicon particles 121 are contained inside the carbon nanotubes 122. Accordingly, a lithium secondary battery using the anode active material 120 has a significantly improved battery capacity and lifetime characteristics with an excellent capacity maintenance rate.

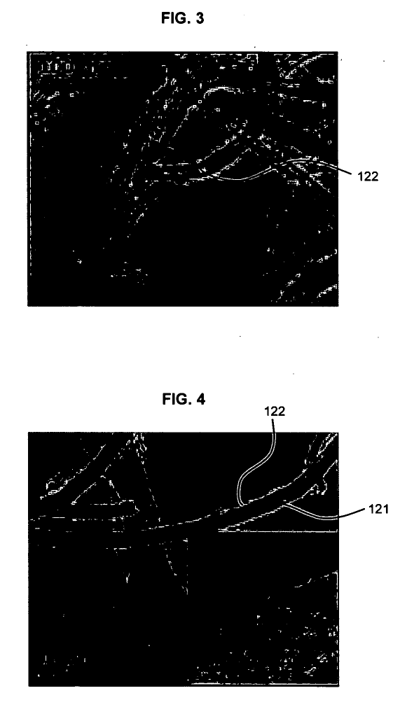

FIG. 2 is a photograph illustrating carbon nanotubes 122, FIG. 3 is a photograph illustrating the carbon nanotubes 122 after being subjected to chemical etching, and FIG. 4 is a photograph illustrating the carbon nanotubes 122 filled with the silicon particles 121.

The anode active material 120 is manufactured by preparing the carbon nanotubes 122, opening up closed end caps of the carbon nanotubes 122, forming the carbon nanotubes 122 to have a predetermined length and filling the carbon nanotubes 122 with silicon particles 121. The silicon particles 121 are selected to have a particle size small enough so that silicon particles can fit in the hollow interior space of the carbon nanotubes.

Carbon nanotubes are formed in a tube shape having an internal hollow space by connecting hexagonal shapes of six carbons to each other in a molecular structure similar to graphite or fullerenes. Types of carbon nanotubes include single wall nanotubes, s multi-wall nanotubes made up of overlapping single wall nanotubes, and nanotube ropes. The anode active material 120 uses s single wall nanotubes or a multi-wall nanotubes so as to easily be filled with the silicon particles. Carbon nanotubes may be synthesized by known methods or may be obtained from commercial sources.

FIG. 3 shows a carbon nanotube in which the end cap has been opened by chemical etching (See the arrow in FIG. 3). In a closed end cap state, carbon nanotubes 122 may have a length of more than 10 μm. In order to fill the carbon nanotubes 122 with silicon particles, the end caps of the carbon nanotubes 122 are opened by chemical etching, and the length of the carbon nanotubes 122 is reduced to the range of 0.1 to 10 μm. The length of the carbon nanotubes 122 may be controlled by controlling the etching time of the chemical etching. When the length of the carbon nanotubes 122 is reduced to less than 0.1 μm, the battery capacity is not sufficiently high because the amount of the silicon particles 121 filling the carbon nanotubes 122 is not sufficient. When the length of the carbon nanotubes 122 is greater than 10 μm, filling the carbon nanotubes 122 with the silicon particles 121 is difficult as mentioned above. As the length of the carbon nanotubes 122 becomes shorter, the filling speed of the carbon nanotubes 122 with the silicon particles 121 becomes faster. Thus, as a non-limiting example, the length of the carbon nanotubes 122 may be in the range of 0.1 to 5 μm. Since chemical etching typically does not provide carbon nanotubes having identical lengths, the lengths mentioned above may represent an average length of the carbon nanotubes.

Referring to FIG. 4, the carbon nanotubes 122 that are opened by removing the end caps and are formed to have a length within a predetermined range by chemical etching method are filled with the silicon particles 121. A chemical vapor deposition method or a liquid phase method may be used to fill the carbon nanotubes 122 with the silicon particles 121. For example, when the liquid phase method is used, the silicon particles are dissolved in an acid solution containing nitric acid (HNO₃) or sulfuric acid (H₂SO₄). The prepared carbon nanotubes 122 are sonicated in the solution and the silicon particles 121 fill the carbon nanotubes 122 by capillary action.

The amount of silicon particles 121 that fill the carbon nanotubes 122 may be controlled by controlling the amount of time that the carbon nanotubes are exposed to a silicon particle-containing vapor or liquid. The greatest possible amount of silicon particles 121 is desirable, since the capacity of the lithium secondary battery is increased according to an increase the amount of the silicon particles 121. However, the amount of silicon particles 121 that can fill the carbon nanotubes 122 is limited by the volume capacity of the carbon nanotubes 122. According to a particular, non-limiting embodiment, silicon particles 121 in the amount of 50 wt % of the total anode active material may fill the carbon nanotubes 122. Since the average length of the carbon nanotubes 122 with the end cap opened is in the range of 0.1 to 10 μm, the silicon particles 121 rapidly fill the carbon nanotubes 122 up to the range that the carbon nanotube 122 can receive. Thus, lifetime degradation of the lithium secondary battery is prevented and the capacity thereof is prominently increased.

Hereinafter, an electrode assembly of the lithium secondary battery according to an embodiment of the present invention will be described.

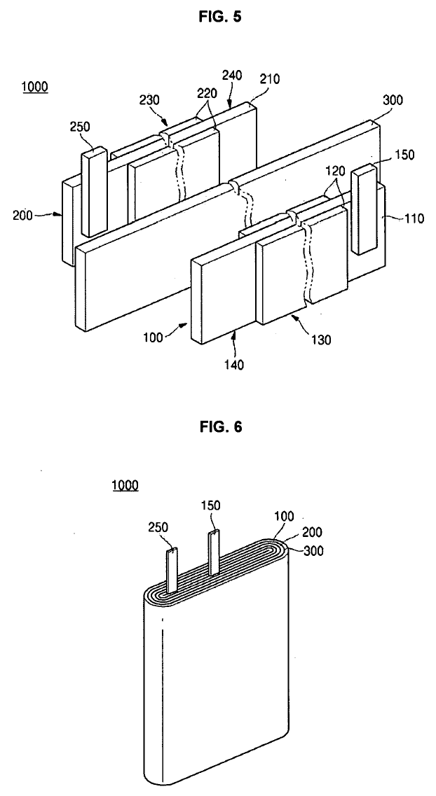

FIG. 5 is an exploded perspective view of the electrode assembly of the lithium secondary battery according to an embodiment of the present invention, and FIG. 6 is a perspective view the electrode assembly shown in FIG. 5 in assembled form. The electrode assembly 1000 of the lithium secondary battery includes a cathode 200 an anode 100 and a separator 300.

The cathode 200 includes a cathode collector 210, a cathode electrode active material layer 220 and a cathode tap 250. The cathode collector 210 may be formed of a thin aluminum foil plate. The cathode collector 210 is coated on both surfaces with a cathode active material layer 220, which mainly comprises lithium group oxides, to form a cathode coated part 230. A cathode uncoated part 240, a region where the cathode active material layer 220 is not coated, is present on both ends of the cathode collector 210. A cathode tap 250, which may be made of nickel, for example, is fixed by ultrasonic wave welding in the cathode uncoated part 240 located in position that will become an internal circumferential portion of the electrode assembly when the electrode assembly is wound. The cathode tap 250 has an upper end fixed so as to protrude above an upper end of the cathode collector 210.

The separator 300 provides a barrier to electronic conduction between the cathode 200 and the anode 100 and is formed of porous material that allows lithium ions to move smoothly. Polyethylene (PE), polypropylene (PP) or a composite polyethylene-polypropylene film may be used for the separator 300. The separator 300 is formed to have a width larger than the width of the anode 100 and the cathode 200 so as to effectively prevent an electric short from being generated in an upper end and a lower end of the anode 100 and the cathode 200.

The separator 300 is interposed between the anode 100 and the cathode 200, and the assembled anode, separator 300 and cathode 200 are wound in a jelly-roll style, thereby forming the electrode assembly of the lithium secondary battery, as shown in FIG. 6. Accordingly, the lifetime characteristics and battery capacity of the lithium secondary battery including the electrode assembly can be prominently improved. It is to be understood that a lithium secondary battery is not limited to the particular embodiment described herein and that the anode active material can be used with electrode assembly structures that differ from what is described.

Hereinafter, aspects of the present invention will be explained in detail according to embodiment. However, the present embodiment is to illustrate the present invention, but not limited thereto.

### EXAMPLES

### Example 1

An anode active material was prepared using carbon nanotubes filled with silicon particles in the amount of 5 wt % of the total active material. A lithium secondary battery was formed using the anode active material.

### Example 2

An anode active material was prepared using carbon nanotubes filled with silicon particles in the amount of 10 wt % of the total active material. A lithium secondary battery was formed using the anode active material.

### Comparative Example 1

An anode active material was prepared using silicon particles without carbon nanotubes. A lithium secondary battery was formed using the anode active material.

### Comparative Example 2

An anode active material was prepared using carbon nanotubes filled with silicon particles in the amount of 5 wt % of the total active material. A lithium secondary battery was formed using the first anode active material.

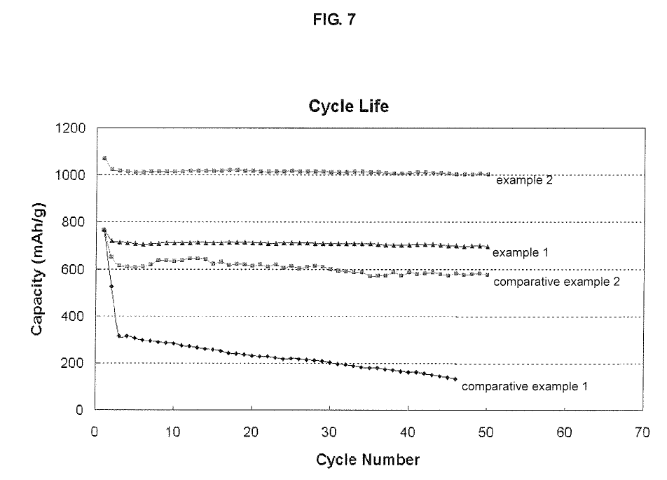

The variation in the battery capacity of each lithium secondary battery was measured while repeating charging/discharging 50 times. FIG. 7 is a graph illustrating the lifetime characteristic of each lithium secondary battery using the respective anode active material.

When only silicon particles are used as the anode active material according to the Comparative Example 1,the silicon particles are continuously shrink and expand during the repetition of the charging/discharging, thereby causing lifetime degradation. When only carbon nanotubes are used as the anode active material according to the Comparative Example 2, the lifetime of the battery does not degrade dramatically, but the battery has a low capacity (less than 600 mAh/g).

When carbon nanotubes filled with silicon particles are used as the anode active material as in Example 1 or Example 2, the lifetime of the battery does not degrade, and the battery capacity is also improved. As shown in Example 2, the battery capacity can be increased even more by increasing the amount of silicon particles filling the carbon nanotubes.

As described above, the anode active material including the carbon nanotubes and the silicon particles according to aspects of the present invention prevents the life degradation of the lithium secondary battery and improves the capacity of the battery. In particular, the carbon nanotubes prevent the silicon particles from shrinking and expanding, thereby preventing degradation of the lifetime of the lithium secondary battery. Further, the use of the carbon nanotubes to hold the silicon particles allows a significant amount of silicon particles to be used in the anode active material, thereby significantly improving the capacity of the lithium secondary battery.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An anode active material, comprising:
carbon nanotubes; and
silicon particles located in internal spaces of the carbon nanotubes.

2. The anode active material of claim 1, wherein the anode active material is formed by filling the carbon nanotubes with the silicon particles.

3. The anode active material of claim 1, wherein the carbon nanotubes have a length in the range of 0.1 to 10 μm.

4. The anode active material of claim 1, wherein the carbon nanotubes have a length in the range of 0.1 to 5 μm.

5. The anode active material of claim 1, wherein the carbon nanotubes are multi-wall nanotubes or single wall nanotubes.

6. The anode active material of claim 1, wherein the silicon particles comprise less than 50 wt % of the anode active material.

7. The anode active material of claim 2, wherein end caps of the carbon nanotubes are removed by chemical etching before the carbon nanotubes are filled with the silicon particles.

8. The anode active material of claim 1, further including a binder to adhere the anode active material to an anode collector.

9. The anode active material of claim 8, wherein the binder comprises polyvinylidene fluoride (PVDF), a copolymer of vinylidene chloride or a styrene-butadiene rubber (SBR).

10. A lithium secondary battery, comprising:
an anode including an anode collector and an anode active material;
a cathode including a cathode collector and a cathode active material; and
a separator interposed between the anode and the cathode, wherein
the anode active material includes carbon nanotubes having interior spaces filled with silicon particles.

11. The lithium secondary battery of claim 10, wherein the anode active material is formed by filling the carbon nanotubes with the silicon particles.

12. A manufacturing method of an anode active material, comprising:
removing end caps of carbon nanotubes to provide carbon nanotubes having open ends; and
filling interior spaces of the carbon nanotubes with silicon particles.

13. The manufacturing method of claim 12, wherein the removing of the end caps of the carbon nanotubes provides carbon nanotubes having lengths of 0.1 to 10 μm.

14. The manufacturing method of claim 12, wherein the end caps of the carbon nanotubes are removed by chemical etching.

15. The manufacturing method of claim 12, wherein the carbon nanotubes are filled with the silicon particles by a capillary action.

16. The manufacturing method of claim 15, wherein the filling of the interior spaces of the carbon nanotubes comprises dissolving silicon particles in an acid solution and sonicating the carbon nanotubes in the acid solution containing the dissolved silicon particles.

17. The manufacturing method of claim 16, wherein the acid solution comprises nitric acid or sulfuric acid.

18. The manufacturing method of claim 12, wherein the carbon nanotubes are filled with the silicon particles by chemical vapor deposition of the silicon particles.

19. An anode active material manufactured by the method of claim 12.
